(19) United States
(12) Patent Application Publication
(10) Pub. No.: US 2017/0364683 A1
(43) Pub. Date: Dec. 21, 2017

(54) COMPUTING DEVICE SECURE BOOT

(71) Applicant: Google Inc., Mountain View, CA (US)

(72) Inventors: Shawn Willden, Morgan, UT (US); Jorge Coronel, Mountain View, CA (US)

(21) Appl. No.: 15/185,891

(22) Filed: Jun. 17, 2016

(51) Int. Cl. G06F 21/57; G06F 12/14; G06F 9/44; G06F 21/53

(52) U.S. Cl. CPC G06F 21/575; G06F 21/53; G06F 12/14; G06F 9/4403; G06F 2212/1052; G06F 2221/2149

(57) ABSTRACT

A device includes a processor, a hardware component, a communication channel between the processor and the hardware component, and a secure memory that stores a baseline value of an electrical characteristic of the connection. The processor is configured to determine, during a boot process of the computing device, a value of the electrical characteristic, the electrical characteristic being one or more of impedance, inductance, capacitance, or frequency response, determine whether the value is within a threshold amount of the baseline value, and, responsive to determining that the value of the electrical characteristic is within the threshold amount, complete the boot process, and, responsive to determining that the value of the electrical characteristic is not within the threshold amount, prevent the computing device from completing the boot process.

### BACKGROUND

Computing devices, including mobile devices, may have protection to prevent an attacker from installing malware on the computing device. For example, a computing device may utilize a digitally signed bootloader and operating system to verify the integrity of the computing device. The computing device may perform various checks to ensure the integrity of the boot drivers, startup files, etc. However, such a computing device may still be vulnerable other types of attacks, such as a hardware attack attempting to read the memory of the computing device during the boot process.

### SUMMARY

In one example, a method may include determining, by a processor of a computing device and during a boot process of the computing device, a value of an electrical characteristic of a connection between the processor and a component of the computing device, wherein the electrical characteristic includes one or more of impedance, inductance, capacitance, or frequency response and determining, by the processor, whether the value of the electrical characteristic is within a threshold amount of a predetermined value of the electrical characteristic. The method may further include, responsive to determining that the value of the electrical characteristic is within the threshold amount of the predetermined value, completing the boot process, and responsive to determining that the value of the electrical characteristic is not within the threshold amount of the predetermined value, preventing the computing device from completing the boot process.

In another example, a computing device may include a processor, one or more hardware components, one or more communication channels configured to provide a respective connection between the processor and each of the one or more hardware components, and a secure memory configured to store a baseline value of respective electrical characteristics for each of the respective connections between the processor and each of the one or more hardware components. The processor may be configured to: determine, during a boot process of the computing device, a value of an electrical characteristic of a particular connection between the processor and one of the one or more hardware components, wherein the electrical characteristic includes one or more of impedance, inductance, capacitance, or frequency response, and determine whether the value of the electrical characteristic of the particular connection is within a threshold amount of the baseline value of the electrical characteristic of the particular connection stored in the secure memory. The processor may be further configured to: responsive to determining that the value of the electrical characteristic of the particular connection is within the threshold amount of the baseline value, complete the boot process, and, responsive to determining that the value of the electrical characteristic of the particular connection is not within the threshold amount of the baseline value, prevent the computing device from completing the boot process.

In another example, a non-transitory computer-readable storage medium is encoded with instructions that, when executed, cause a processor of a computing device to determine, during a boot process of the computing device, a value of an electrical characteristic of a connection from the processor to a component of the computing device, wherein the electrical characteristic includes one or more of impedance, inductance, capacitance, or frequency response and determine whether the value of the electrical characteristic is within a threshold amount of a predetermined value of the electrical characteristic. The instructions may further cause the processor to, responsive to determining that the value of the electrical characteristic is within the threshold amount of the predetermined value, complete the boot process; and responsive to determining that the value of the electrical characteristic is not within the threshold amount of the predetermined value, prevent the computing device from completing the boot process.

The details of one or more examples are set forth in the accompanying drawings and the description below. Other features, objects, and advantages of the disclosure will be apparent from the description and drawings, and from the claims.

### BRIEF DESCRIPTION OF DRAWINGS

The details of one or more examples of the disclosure are set forth in the accompanying drawings and the description below. Other features, objects, and advantages will be apparent from the description and drawings, and from the claims.

FIG. 1 is a block diagram illustrating an example computing device configured to measure electrical characteristics of connections between components of the computing device, in accordance with one or more aspects of the present disclosure.

FIG. 2 is a schematic diagram illustrating details of an example computing, in accordance with one or more aspects of the present disclosure.

FIGS. 3A and 3B are a flow diagrams illustrating example operations for determining baseline values for electrical characteristics while a computing device is operating in a secure environment and for performing a secure boot process, in accordance with one or more techniques of the present disclosure.

### DETAILED DESCRIPTION

In general, techniques of this disclosure may enable a computing device to detect variations in current values of electrical characteristics of one or more connections between components of the computing device as compared to previously determined values for the corresponding electrical characteristics of the connections. In various instances, in response to detecting such variations, the computing device may be configured to prevent the computing device from booting. For example, the computing device may be configured with a predetermined value for an electrical connection between a processor of the computing device and a memory of the computing device. During initiation of a boot sequence of the computing device, the computing device may retrieve a stored value of an electrical characteristic of the connection between the processor and the memory, determine a current value of the electrical characteristic of the connection, and, if the difference between the predetermined value and the current value is greater than a threshold amount, prevent the computing device from completing the boot sequence.

By detecting changes in values of electrical characteristics of connections between components of the computing device, the computing device may provide a more secure environment and may prevent unauthorized access to the computing device. For example, if an attacker inserts a probe, multiplexer, or other device between components of the computing device, the presence of the probe may change the value of one or more electrical characteristics of a connection between the components that may be detectable by the computing device. In this way, the computing device may verify the integrity of the communication path between various components of the computing device and may protect the computing device against such “man-in-the-middle” attacks.

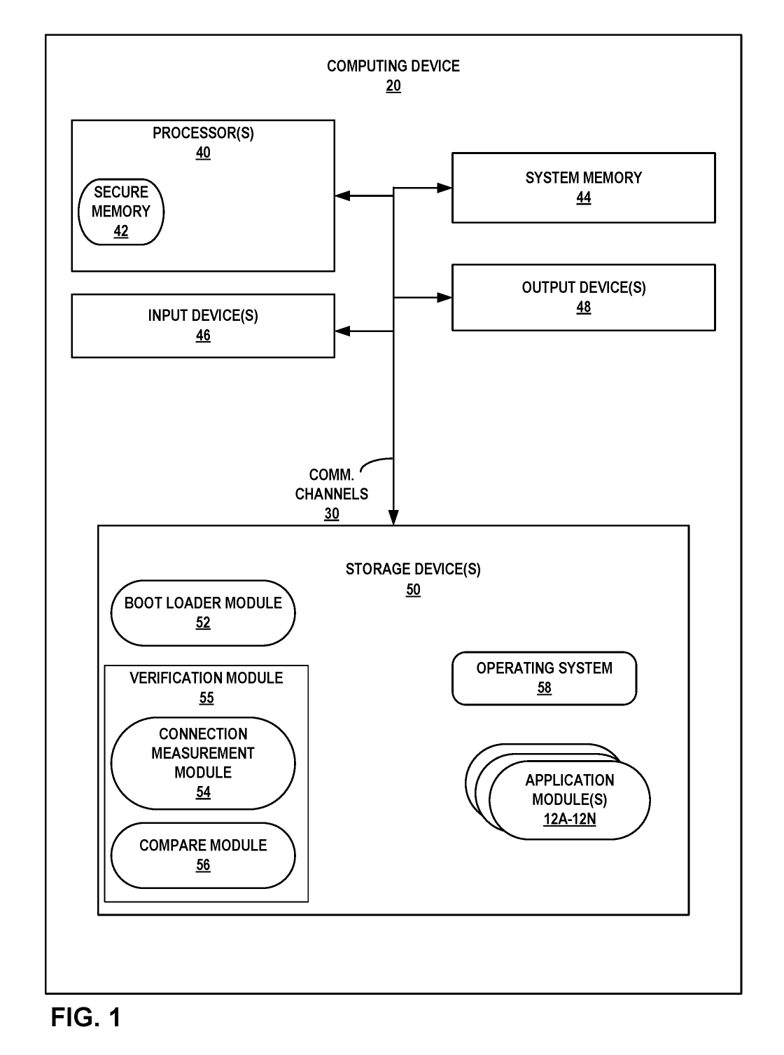

FIG. 1 is a block diagram illustrating example computing device 20 configured to measure electrical characteristics of connections between components of computing device 20, in accordance with one or more aspects of the present disclosure. Examples of computing device 20 may include, but are not limited to, portable or mobile devices such as mobile phones (including smart phones), wearable computers (which may include smartwatches, activity trackers, etc.), laptop computers, desktop computers, tablet computers, smart television platforms, personal digital assistants (PDAs), remote controllers, gaming systems, servers, mainframes, etc.

As shown in the example of FIG. 1, computing device 20 may include one or more processors 40, a system memory 44, input devices 46, and output devices 43, which may each be connected to one or more storage devices 50 by communication channels 30. In some examples, communication channels 30 may include a system bus, network connection, inter-process communication data structure, or any other channel for communicating data. Storage device 50 may store a boot loader module 52, verification modules 55, the operating system 58, and one or more application modules (12A-12N). Each of components 40, 44, 46, 48, and 50 may be interconnected (physically, communicatively, and/or operatively) for inter-component communications. Other examples of a computing device 20, may include a subset of the components or may include additional components not shown in FIG. 1. In some examples, one or more processors 40, communication channels 30, system memory 44 and other hardware components that may not be shown in FIG. 1 may be configured as an isolated system on a chip (SoC). That is, the SoC may be physically separated from the other portions of computing system 20 for additional security.

One or more processors 40 may implement functionality and/or execute instructions associated with computing device 20. Examples of processors 40 include application processors, display controllers, auxiliary processors, one or more sensor hubs, and any other hardware configure to function as a processor, a processing unit, or a processing device. Modules 12, 52, 54, 55 and 56 may be operable by processors 40 to perform various actions, operations, or functions of computing device 20. For example, processors 40 of computing device 20 may retrieve and execute instructions stored by storage components 50 that cause processors 40 to perform the operations modules 12, 52, 54, 55 and 56. The instructions, when executed by processors 40, may cause computing device 20 to store information within storage components 50.

Processor 40 may include secure memory 42, which may be part of the same integrated circuit as processor 40, a memory component of a system on chip (SoC),or a discrete component coupled to processor 40. Secure memory 42 may include one-time programmable (OTP) read-only memory (ROM). In such examples, the OTP ROM may include any combination of hardware fuses, hardware anti-fuses, or software fuses. A software fuse may be a dedicated memory area that, once programmed, cannot be reprogramed without erasing a portion of memory. The software fuse may protect memory from tampering or unauthorized disclosure by forcing an erase of sensitive data if there is an unauthorized access attempt on the memory. The forced erase may disable the device or system, which may prevent damage or disclosure of confidential data. In some examples, a software fuse may also be referred to as a joint test action group (JTAG) fuse. Other examples of secure memory 42 include on-chip static random access memory (SRAM), erasable programmable read only memory (EPROM), electrically erasable PROM (EEPROM) and similar types of memory that may either be programmed in a secure environment using specific programming equipment (a “programmer”) or while in operation. Secure memory 42 may be included within a dedicated hardware processor distinct from processor 40.

System memory 44 may be may be random access memory (RAM), dynamic RAM (DRAM), other forms of DRAM such as synchronous DRAM (SDRAM), double data rate SDRAM (e.g. DDR1 SDRAM, DDR2 SDRAM, etc.) and similar types of computer memory. System memory 44 may be implemented as one or more external memory modules connected as a bank of memory and accessible by processor 40 using a directly connected memory bus or accessible by other system components using communication channels 30. System memory 44 may be configured as single in-line memory modules (SIMM), dual in-line memory modules (DIMM), Rambus in-line memory modules (RIMM), or other interconnection configurations. Processor 40 may store information at system memory 44 for use in performing operations. For example, processor 40 may cause data to be moved from storage device 50 into system memory 44. In some examples, the information may be instructions that processor 40 may use to perform an operation. After performing an operation using the information retrieved from storage device 50 and stored at system memory 44, processor 40 may cause the data from system memory 44 to be written back to storage device 50. In some examples, processor 40 may perform subsequent operations using the information stored at system memory 44.

Computing device 20 may include input devices 46. In some examples, input devices 46 may include motion sensors, one or more location sensors (e.g., a global positioning system (GPS) sensor, an indoor positioning sensor, or the like), one or more light sensors, one or more temperature sensors, one or more pressure (or grip) sensors, one or more physical switches, one or more proximity sensors, and one or more bio-sensors that can measure properties of the skin/blood, such as oxygen saturation, pulse, alcohol, blood sugar, etc. The example of FIG. 1 shows input devices 46 as internal to computing device 2, but in other examples, input devices 46 may include components that are external to computing device 2. One example may be an external keyboard connected via wired or wireless connection. Other examples may include a touch sensitive screen that may be part of output devices 48.

One or more output components 48 of computing device 20 may generate output. Examples of output are tactile, audio, and video output. Output components 48 of computing device 20, in one example, includes a presence-sensitive display, sound card, video graphics adapter card, speaker, cathode ray tube (CRT) monitor, liquid crystal display (LCD), or any other type of device for generating output to a human or machine.

One or more storage components 50 within computing device 20 may store information for processing during operation of computing device 20 (e.g., computing device 20 may store data accessed by modules 52, 54, and 56 during execution at computing device 20). In some examples, storage component 50 is a temporary memory, meaning that a primary purpose of storage component 50 is not long-term storage. Storage components 50 on computing device 20 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 50, in some examples, also include one or more computer-readable storage media. Storage components 50 in some examples include one or more non-transitory computer-readable storage mediums. Storage components 50 may be configured to store larger amounts of information than typically stored by volatile memory. Storage components 50 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 50 may store program instructions and/or information (e.g., data) associated with modules 52, 54, and 56. Storage components 50 may include a memory configured to store data or other information associated with modules 52, 54, and 56.

Operating system 58 may control one or more functionalities of computing device 20 and/or components thereof. For example, operating system 58 may interact with any of boot loader module 52, verification modules 55, and application modules 12A-12N and may facilitate one or more interactions between the respective modules and processors 40, system memory 44, input devices 46, and output devices 48. Although not shown in FIG. 1, operating system 58 may interact with, or be otherwise coupled to, any of the modules described above, as well as to any components thereof. In some examples, one or more of the modules described above may be included within (or be otherwise provided by) operating system 58.

Computing device 20 may include boot loader module 52 and verification modules 55, which may include connection measurement module 54, and compare module 56. Modules 52, 54, 55 and 56 may perform operations described using software, hardware, firmware, or a mixture of hardware, software, and firmware residing in and/or executing at computing device 20. For example, one or more processors 40 of computing device 20 may execute instructions that are stored at a memory or other non-transitory storage medium of computing device 20 (e.g., system memory 44, storage devices 50, etc.) to perform the operations of modules 52, 54, 55 and 56. Computing device 20 may execute modules 52, 54, 55 and 56 as virtual machines executing on underlying hardware. As other examples, modules 52, 54, 55 and 56 may execute as one or more services of an operating system or computing platform, or modules 52, 54, 55 and 56 may execute as one or more executable programs at an application layer of a computing platform.

Application modules 12 represent all the various individual applications and services executing at and accessible from computing device 20. A user of computing device 20 may interact with a graphical user interface associated with one or more application modules 12 to cause computing device 20 to perform a function. Application modules may include, a word processing application, spreadsheet or calculator application, a fitness application, a calendar application, a personal assistant or prediction engine, a search application, a map or navigation application, a transportation service application (e.g., a bus or train tracking application), a social media application, a game application, an e-mail application, a chat or messaging application, an Internet browser application, or any and all other applications that may execute at computing device 20. Some examples of applications 12 may include trustlet applications. Trustlet applications may include applications run in a specialized, secure operating system that may be isolated from other portions of the computing system. Some trustlet applications may need to be encrypted, digitally signed and securely transferred to the isolated portion of the computing system to operate properly.

In accordance with techniques of this disclosure, computing device 20 may determine electrical characteristics of one or more connections between components of computing device 20 while computing device 20 is booting. For example, computing device 20 may receive an input to power on or restart, and, in response, initiate a boot process. In the example of FIG. 1, to begin the boot process, processor 40 may execute boot loader module 52, which may cause processor 40 execute verification module 55. Verification module 55 may be configured as a kernel, microkernel, or a trustlet application.

Connection measurement module 54 of verification module 55 may include instructions that cause processor 40 to determine one or more electrical characteristics of one or more connections between components of computing device 20 (e.g., one or more of communication channels 30). The electrical characteristics may include any one or more of impedance, inductance, capacitance, or frequency response as well as timing delay, timing difference, step function response, overshoot, or damping, and other parameters not listed. For example, processor 40 may measure inductance of a communication channel 30 between processor 40 and system memory 44. As another example, processor 40 may measure the power supply pin impedance value for processor 40. In other words, processor 40 may determine the impedance between its own power supply pin and a power supply rail of computing device 20.

Processor 40 may execute compare module 56 to compare measured electrical characteristics to baseline values stored at secure memory 42. For example, compare module 56 may determine whether the power supply pin impedance value is within a threshold amount of a baseline power supply pin impedance reference value stored at secure memory 42. Responsive to determining that the impedance value satisfies the threshold, processor 40 may complete the boot process and load operating system 58.

However, if the impedance value does not satisfy the threshold, compare module 56 may cause computing device 2 to cease booting, which may prevent an attacker from gaining access to information stored within computing device 2. In various instances, a measured power supply pin impedance value that does not satisfy the threshold amount of the predetermined baseline impedance value may indicate an attacker has tampered with computing device 2.

An attacker may gain physical access to computing device 20 and insert a probe, multiplexer or some other device or instrument between one or more components of computing device 20, which may change some of the electrical characteristics of electrical connections of computing device 20. As one example, an attacker may determine which encryption algorithm computing device 20 may be using by measuring the power consumption of processor 40. The attacker may probe the power supply connection pin for processor 40 to measure power consumption of processor 40. The attacker's probe may cause the power supply pin impedance to fall outside the threshold power supply pin impedance stored at secure memory location 42.

Responsive to compare module 56 determining that the power supply pin impedance does not satisfy the threshold, boot loader module 52 may prevent computing device 2 from completing the boot process. That is, if the values of the electrical characteristics are out of tolerance, verification module 55 may determine that the integrity of computing device 20 has been compromised and instruct boot loader module 52 to terminate the boot process. By stopping the boot process prior to completion, techniques of this disclosure may prevent an attacker from compromising the security of computing device 2 by preventing the attacker from gaining information about the encryption algorithm used by computing device 2. In instances where verification module 55 verifies the integrity of computing device 20 (i.e., determines that no malicious attack is detected), boot loader module 52 may continue the boot process by, for example, loading device drivers for input devices 46, initializing system memory 44, loading operating system 58, and/or displaying a message on one of output devices 48. In this way, techniques of this disclosure may prevent an attacker from compromising the information or processes stored at computing device 2.

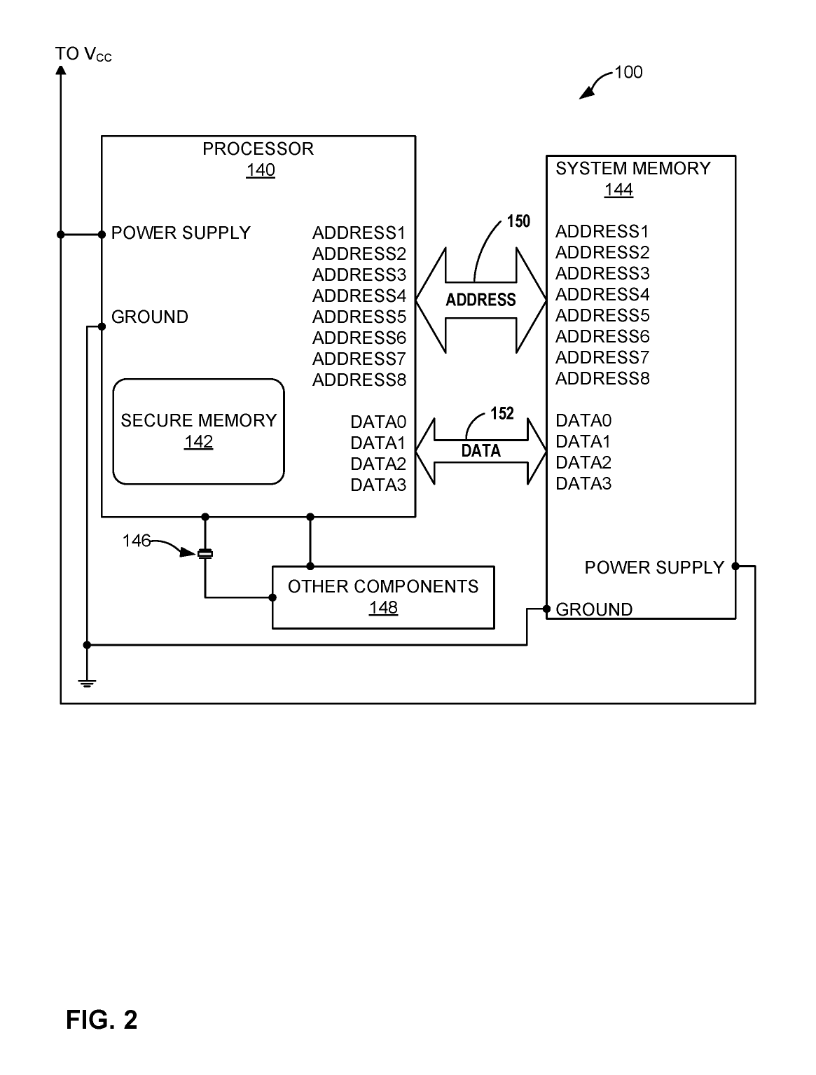

FIG. 2 is a schematic diagram illustrating details of an example computing device 100, in accordance with one or more aspects of the present disclosure. Computing device 100 may include processor 140 and system memory 144, each connected to power supply Vcc and to ground. Processor 140 may include a secure memory location 142, which may be similar to secure memory 42 shown in FIG. 1. Processor 140 and system memory 144 may be connected by a direct memory bus, which may include address connections 150 and data connections 152. Processor 140 and system memory 144 may connect to each other by connections not shown as well as to other components not shown in the example of FIG. 2. Processor 140 may connect to other components 148, such as through oscillator 146. Other examples of computing device 100 may include additional components not shown in FIG. 2.

In accordance with the techniques of this disclosure, secure memory 142 may store baseline values for various electrical characteristics of connections between processor 140 and system memory 144 (e.g., connections 150, 152) and between processor 140 and other components 148. As discussed above, the electrical characteristics may include impedance and inductance of connections between components of computing device 100. The electrical characteristics may also include timing delay, timing difference, step function response, overshoot, or damping. For example, processor 140 may send a series of clock pulses to other components 148. One or more of other components 148 may return a response to the series of clock pulses that may have a timing delay. Processor 140 may determine the timing delay of the response during operation, or during the boot process. Processor 140 may compare the timing delay to a baseline timing delay stored at secure memory 142.

The baseline timing delay as well as other baseline values for the electrical characteristics may be stored within secure memory 142. Computing device 100 may determine the baseline values while operating in a secure environment (e.g., a device assembly facility). As used in this disclosure, a secure environment may be a geographic location and facility where computing device 100, as an example, may determine the baseline values of the electrical characteristics with a low likelihood that someone is tampering with computing device 100 at the time the baseline values are determined. This should not be confused with a “trusted environment,” which may be a secure area of a processor, e.g. processor 140, where sensitive data and operations may be isolated and processed. A trusted environment within the processor may be where sensitive operations may occur, such as encryption and decryption or verifying credentials (e.g. for banking or other transactions).

While operating in the secure environment, processor 140 may determine baseline values for electrical characteristics of connections of a fully assembled computing device 100 or a subassembly of computing device 100. For example, a subassembly may include a printed circuit board, processor 140, system memory 144, oscillator 146 and other components 148 as shown in FIG. 2. Test equipment in the secure environment may cause processor 140 to determine the impedance and capacitance of one or more connections between processor 140 and system memory 144. For example, processor 140 may determine the impedance and capacitance for each of address lines 150 (ADDRESS1-ADDRESS8). Similarly, processor 140 may determine the impedance and capacitance of each of data lines 152 (DATA0-DATA3). Processor 140 may store the baseline values of the electrical characteristics in secure memory 142. In other examples, other equipment such as an eraseable programmable read-only memory (EPROM) programmer, also operating in the secure environment, may store the baseline electrical characteristics at secure memory 142. In yet another example, test equipment connected to a subassembly of computing device 100, may determine component connection electric characteristics distinct from processor 140. In other words, in various examples, the test equipment, not processor 140, may determine the impedance and capacitance of address lines 150, then store the baseline values at secure memory location 142.

In one example, secure memory 142 may include one-time programmable (OTP) hardware fuses in a read-only memory (ROM), hardware antifuses, or software fuses. Hardware fuses may be arranged as a grid, array or other structure such that each fuse is made up of one bit. An unblown hardware fuse may be considered the value “1” by default, and applying a current at a prescribed level for a prescribed duration (e.g., with a programmer) may blow certain fuses in the array, which may set those bits to a zero. In other examples a programmer may apply heat, such as a laser beam or infrared beam, to cut or melt the hardware fuse. In this way, the blown and un-blown hardware fuses may store the baseline values and the values cannot be changed by reprogramming.

Hardware antifuses may work in substantially the opposite way. Similar to hardware fuses, the hardware antifuses may be arranged as a grid, matrix or other structure. However, rather than defaulting to the value “1”, unblown hardware antifuse may default to the value “0” because a dielectric or insulator may block current flow. To store the baseline values of the electrical characteristics, a programmer, or other means, applies current or heat to the insulator to blow the fuse, thus converting the antifuse from the value “0” to being the value “1”. The combination of bits may securely store the baseline values. Anti-fuses may be combined in the same structure as fuses, in some examples.

A software fuse may be a dedicated memory area that, once programmed, cannot be reprogrammed without erasing a portion of memory. The software fuse may protect memory from tampering or unauthorized disclosure by forcing an erase of sensitive data if there is an unauthorized access attempt on the memory.

In the example where secure memory 142 may include a hardware processor, storing the baseline values may include activating the hardware processor, taking ownership and setting the ownership authorization, storing the values, and sealing the data. During operation, the computing device may retrieve the baseline values using an access key code. The hardware processor may prevent an attacker from tampering with the baseline values without the ownership authorization codes. In some examples, the hardware processor may conform to the trusted platform module (TPM) standard.

At some time after computing device 100 determines and stores the baseline values for the various electrical characteristics of one or more of the connections between processor 140 and system memory 144 and other components 148, computing device 100 may receive an input to power on or restart computing device 100. Responsive to receiving the input, computing device 100 may initiate a boot process. During the boot process, processor 140 may initialize system memory 144, load and execute device drivers and other modules, and/or load and being executing an operating system.

In accordance with techniques of this disclosure, during the boot process, processor 140 may also determine current values of various electrical characteristics of at least a portion the intra-device component connections. For example, processor 140 may retrieve baseline value for the electrical characteristics of various connections from secure memory 142 and may determine current (i.e., current in time) impedance and capacitance of one or more of address lines 150, one or more of data lines 152, or one or more the connections to other components 148.

As one example, processor 140 may determine the current impedance and capacitance values for the address line 150 that is associated with ADDRESS1. Processor 140 may load the baseline impedance and capacitance values for the address line 150 associated with ADDRESS1 from secure memory 142 and compare the current impedance and capacitance values for the address line 150 to the retrieved baseline impedance and capacitance values. Processor 140 may determine whether the impedance and capacitance values for address line 150 are within a threshold amount of the baseline impedance and capacitance values for address line 150. If processor 140 determines that either or both of the current impedance and capacitance values for address line 150 are within a threshold of the baseline values (i.e., satisfy the threshold), processor 140 may continue the boot process. However, if processor 140 determines that either or both of the current impedance and capacitance values for address line 150 are not within a threshold of the baseline values (i.e., do not satisfy the threshold), processor 140 may prevent computing device 100 from finishing the boot process and, instead of booting, may cause computing device 100 to power off.

While described as determining current impedance and capacitance values for a single address line, processor 140 may check all or a subset of each of address lines 150, data lines 152, and connections to other components 148. If all of the current values for the electrical characteristics of any of address lines 150, any of data lines 152, any of the connections to components 148, or any combination thereof do satisfy the threshold (i.e., the current value of the electrical characteristics of all of the connections is within a predefined amount), processor 140 continues the boot process. If any of the current values for the electrical characteristics of any of address lines 150, any of data lines 152, any of the connections to components 148, or any combination thereof do not satisfy the threshold (i.e., the current value for any of the connections more than a predefined amount different from the corresponding baseline value for the connection), processor 140 may prevent computing device 100 from completing the boot process. By preventing computing device 100 from completeing the boot process in response to determining that at least one current value of at least one electrical characteristics of at least one connection between processor 140 and one or more of system memory 144 or other components 148 is out of tolerance (i.e., does not satisfy the threshold), techniques of this disclosure may enable computing device 100 to detect a potential man-in-the-middle attack and prevent the potential attacker from gaining access to information stored by computing device 100 or monitoring activity of computing device 100.

In various instances, over time, the values of the electrical characteristics may drift away from the baseline values even though no one is attempting a man-in-the-middle attack. For example, the capacitance of a ceramic capacitor may decrease over time. The crystalline structure of the dielectric of a ceramic capacitor may slowly transition to a slightly different structure, which may cause a predictable change in capacitance as the component ages. As another example, for a capacitor held at constant direct current (DC) bias, the capacitance may predictably decay over time. To account for the decay and resulting drift in values, processor 140 may apply one or more correction factors to the current values when comparing the current values of the electrical characteristics to the baseline values stored in secure memory 142. By applying such correction factors, processor 140 may account for changes in electrical characteristics caused by effects of component aging or by the operating environment.

In addition to component aging, the values of the electrical characteristics may change due to changes in the operating environment (e.g., temperature, humidity, etc.). For example, conductive materials tend to increase resistance with an increase in temperature while insulators tend to decrease resistance with an increase in temperature. During the boot process, processor 140 may determine the current environmental conditions of computing device 100, such as the current temperature, humidity, etc., determine a correction factor, and apply the correction factor to the determined values prior to comparing the current values to the baseline values. Processor 140 may apply a correction factor to any of the threshold, the measured value or to the baseline value.

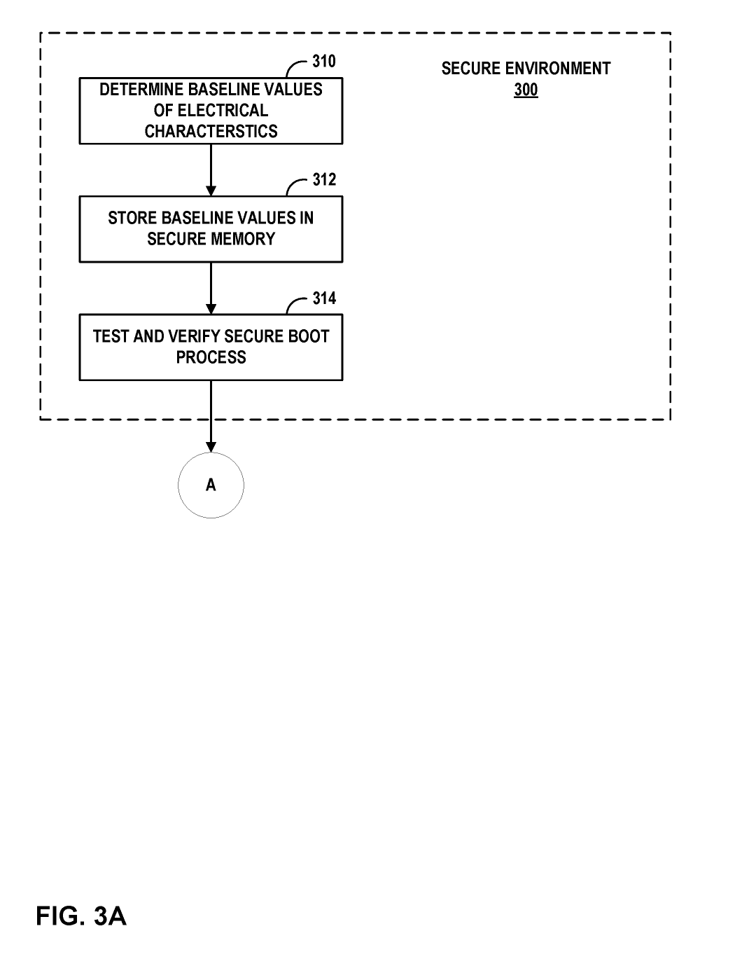

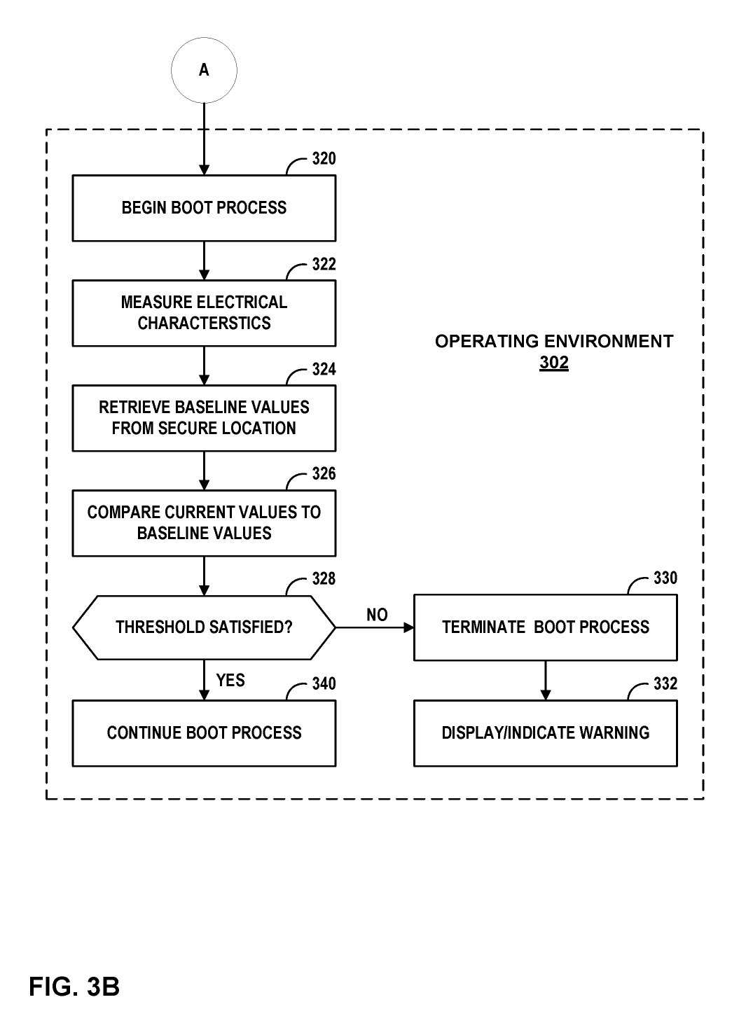

FIGS. 3A and 3B are a flow diagrams illustrating example operations for determining baseline values for electrical characteristics while a computing device is operating in a secure environment and for performing a secure boot process, in accordance with one or more techniques of the present disclosure. The techniques of FIG. 3A may be performed by one or more processors of a computing device, such as computing device 20 of FIG. 1 or computing device 100 of FIG. 2. For purposes of illustration, the techniques of FIG. 3A are described within the context of computing device 20 of FIG. 1, although computing devices having configurations different than that of computing device 20 may perform the techniques of FIG. 3A.

While operating in secure environment 300, processor 40 of computing device 20 may determine one or more baseline values of one or more electrical characteristics of one or more connections between processor 40 and other hardware components of computing device 20 (310). Examples of electrical characteristics include one or more of impedance, inductance, capacitance, frequency response, a timing delay, a timing difference, a step function response, an overshoot, or damping.

Processor 40 may store the baseline electrical characteristics in secure memory 42 (312). In other examples, such as where secure memory 42 includes OTP ROM implemented by an array of hardware fuses or anti-fuses, a programmer, external to computing device 20, may program the baseline values of the electrical characteristics in secure memory 42. In examples where secure memory 42 includes an EPROM, a programmer may store the baseline values in secure memory 42. Where secure memory 42 is included within a hardware processor distinct from processor 40, either computing device 20 or an external programmer may initialize and set ownership of the hardware processor and store the baseline values. Computing device 20 may test and verify the secure boot process function while in the secure environment (314). The test and verification process may include a normal start-up, a simulated man-in-the-middle attack, and other tests.

After computing device 20 has determined and stored the baseline values, computing device 20 may be powered on or rebooting in operating environment 302 distinct from secure environment 300, as shown in FIG. 3B. Operating environment 302 may be a typical operating environment of computing device 20, such as when computing device 20 is in the possession of an end user. Responsive to receiving an input to power on or reboot, boot loader module 52 of computing device 20 may initiate a boot process (320). During the boot process, boot loader module 52 may initialize hardware components, check connections to external devices, retrieve portions of computer code that in turn retrieve additional computer code, etc.

Prior to completing the boot process, boot loader module 52 may cause connection measurement module 54 of computing device 20 may determine values for one or more electrical characteristics of one or more connections between one or more components of computing device 20 (322). For example, connection measurement module 54 may determine the impedance of a connection between processor 40 and system memory 44. As another example, connection measurement module 54 may determine a timing of clock pulses of an oscillator positioned between processor 40 and another hardware component of computing device 20 (e.g., oscillator 146 of FIG. 2 positioned between processor 140 and other components 148). In various instances, connection measurement module 54 may also determine values for accelerometer capacitance, power supply component inductance, etc.

Compare module 56 may retrieve the previously determined baseline values for electrical characteristics corresponding to the current values of the electrical characteristics determined by connection measurement module 54 from secure memory 42 (324). For example, compare module 56 may decode the values stored by hardware fuses of an OTP ROM or read values from an EPROM or EEPROM. In examples where secure memory 42 includes a hardware processor, compare module 56 may provide a security key to unlock or ‘unwrap’ the baseline values, such as the baseline timing difference between clock pulses.

Compare module 56 may compare the current values of the electrical characteristics to the baseline values of the corresponding electrical characteristics (326). Compare module 56 may compare the raw current values to the baseline values or may apply a correction factor to the raw current values and compare the adjusted current values to the baseline values. In either example, if the current values are within a threshold amount of the predetermined baseline value, then compare module 56 may determine that the threshold is satisfied (“YES” branch of 328). If the current values are not within the threshold amount of the baseline values, compare module 56 may determine that the threshold is not satisified (“NO” branch of 328).

Responsive to determining the current values of the electrical characteristic satisfy the threshold (“YES” branch of 328), boot loader module 52 may continue the boot process (340). Boot loader module 52 may continue the boot process by initializing other hardware components of computing device 20, such as wireless communication components, display components, input components, etc. Boot loader module 52 may also load an operating system and one or more applications.

Responsive to determining the current values of the electrical characteristic do not satisfy the threshold (“NO” branch of 328), boot loader module 52 may terminate the boot process and prevent computing device 20 from completing the boot process (330). In terminating the boot process, boot loader module 52 may shut down computing device 20 or may cause computing device 20 to display a warning that the secure boot process prevented computing device 20 from completing the boot process (332).

Example 1. A method comprising: determining, by a processor of a computing device and during a boot process of the computing device, a value of an electrical characteristic of a connection between the processor and a component of the computing device, wherein the electrical characteristic includes one or more of impedance, inductance, capacitance, or frequency response; determining, by the processor, whether the value of the electrical characteristic is within a threshold amount of a baseline value of the electrical characteristic; responsive to determining that the value of the electrical characteristic is within the threshold amount of the baseline value, completing the boot process; and responsive to determining that the value of the electrical characteristic is not within the threshold amount of the baseline value, preventing the computing device from completing the boot process.

Example 2. The method of example 1, further comprising: retrieving, from a secure memory of the computing device, the baseline value of the electrical characteristic of the connection.

Example 3. The method of example 2, wherein the secure memory is a one-time programmable read-only memory that includes one or more of hardware fuses, hardware antifuses, or software fuses.

Example 4. The method of any of examples 2-3, wherein the secure memory is included within one or more of a system memory of the computing device, the processor of the computing device, or a dedicated hardware processor distinct from the processor.

Example 5. The method of any of examples 1-4, wherein the electrical characteristic includes one or more of impedance, inductance, capacitance, frequency response, timing delay, timing difference, step function response, overshoot, or damping.

Example 6. The method of any of examples 1-5, wherein determining, by the processor, whether the value of the electrical characteristic is within the threshold amount of the baseline value of the electrical characteristic comprises: applying a correction factor to the value of the electrical characteristic to generate an corrected value of the electrical characteristic; and determining whether the corrected value of the electrical characteristic is within the threshold amount of the baseline value of the electrical characteristic.

Example 7. The method of any of examples 1-6, further comprising, while the computing device is operating in a secure environment: determining, by the computing device, the baseline value of the electrical characteristic of the connection from the processor to the component of the computing device; and storing, by the computing device, the baseline electrical characteristic in a secure memory of the computing device.

Example 8. The method of example 7, wherein the secure environment is an assembly site of the computing device.

Example 9. A computing device comprising: a processor; one or more hardware components; one or more communication channels configured to provide a respective connection between the processor and each of the one or more hardware components; and a secure memory configured to store a baseline value of respective electrical characteristics for each of the respective connections between the processor and each of the one or more hardware components, wherein the processor is configured to: determine, during a boot process of the computing device, a value of an electrical characteristic of a particular connection between the processor and one of the one or more hardware components, wherein the electrical characteristic includes one or more of impedance, inductance, capacitance, or frequency response; determine whether the value of the electrical characteristic of the particular connection is within a threshold amount of the baseline value of the electrical characteristic of the particular connection stored in the secure memory; responsive to determining that the value of the electrical characteristic of the particular connection is within the threshold amount of the baseline value, complete the boot process; and responsive to determining that the value of the electrical characteristic of the particular connection is not within the threshold amount of the baseline value, prevent the computing device from completing the boot process.

Example 10. The computing device of example 9, wherein the processor is configured to determine whether the value of the electrical characteristic is within a threshold amount of a baseline value of the electrical characteristic by at least being configured to: apply a correction factor to the value of the electrical characteristic to generate an corrected value of the electrical characteristic; and determine whether the corrected value of the electrical characteristic is within the threshold amount of the baseline value of the electrical characteristic.

Example 11. The computing device of any of examples 9-10, wherein the processor is configured to, while the computing device is operating in a secure environment: determine the baseline value of the electrical characteristic of the particular connection between the processor and the one of the one or more hardware components; and store the baseline value of the electrical characteristic of the particular connection in the secure memory.

Example 12. The computing device of any of examples 9-11, wherein the secure memory is a one-time programmable (OTP) read-only memory (ROM), and wherein the ROM includes one or more of hardware fuses, hardware anti-fuses, or software fuses.

Example 13. The computing device of any of examples 9-12, wherein the secure memory is included within one or more of a system memory of the computing device or the processor.

Example 14. The computing device of any of examples 9-13, wherein the electrical characteristic includes one or more of impedance, inductance, capacitance, frequency response, timing delay, timing difference, step function response, overshoot, or damping.

Example 15. The computing device of any of examples 9-14 further comprising a system on a chip that includes the processor and the secure memory.

Example 16. A non-transitory computer-readable storage medium encoded with instructions that, when executed, cause a processor of a computing device to: determine, during a boot process of the computing device, a value of an electrical characteristic of a connection from the processor to a component of the computing device, wherein the electrical characteristic includes one or more of impedance, inductance, capacitance, or frequency response; determine whether the value of the electrical characteristic is within a threshold amount of a baseline value of the electrical characteristic; responsive to determining that the value of the electrical characteristic is within the threshold amount of the baseline value, complete the boot process; and responsive to determining that the value of the electrical characteristic is not within the threshold amount of the baseline value, prevent the computing device from completing the boot process.

Example 17. The non-transitory computer-readable medium of example 16, wherein the instructions further cause the processor to: retrieve, from a secure memory of the computing device, the baseline value of the electrical characteristics of the connection.

Example 18. The non-transitory computer-readable medium of example 17, wherein the instructions further cause the processor to, while the computing device is operating in a secure environment: determine the baseline value of the electrical characteristic of the connection from the processor to the component of the computing device; and store the baseline electrical characteristic in the secure memory.

Example 19. The non-transitory computer-readable medium of any of examples 17-18, wherein the secure memory is a one-time programmable (OTP) read-only memory (ROM), and wherein the ROM includes one or more of hardware fuses, hardware anti-fuses, or software fuses.

Example 20. The non-transitory computer-readable medium of any of examples 17-18, wherein the secure memory is included within one or more of a system memory of the computing device, or the processor of the computing device.

Example 21. The non-transitory computer-readable medium of any of examples 16-20, wherein the electrical characteristic includes one or more of impedance, inductance, capacitance, frequency response, timing delay, timing difference, step function response, overshoot, or damping.

Example 22. A system comprising means for performing any of the methods of examples 1-8.

Example 23. A computing device comprising means for performing any of the methods of examples 1-8.

Example 24. A computer-readable storage medium comprising means for performing any of the methods of examples 1-8.

Throughout the disclosure, examples are described where a computing device and/or a computing system analyzes information (e.g., context, locations, speeds, search queries, etc.) associated with a computing device and a user of a computing device, only if the computing device receives permission from the user of the computing device to analyze the information. For example, in situations discussed below, before a computing device or computing system can collect or may make use of information associated with a user, the user may be provided with an opportunity to provide input to control whether programs or features of the computing device and/or computing system can collect and make use of user information (e.g., information about a user's current location, current speed, etc.), or to dictate whether and/or how to the device and/or system may receive content that may be relevant to the user. In addition, certain data may be treated in one or more ways before it is stored or used by the computing device and/or computing system, so that personally-identifiable information is removed. For example, a user's identity may be treated so that no personally identifiable information can be determined about the user, or a user's geographic location may be generalized where location information is obtained (such as to a city, ZIP code, or state level), so that a particular location of a user cannot be determined. Thus, the user may have control over how information is collected about the user and used by the computing device and computing system.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A method comprising:
determining, by a processor of a computing device and during a boot process of the computing device, a value of an electrical characteristic of a connection between the processor and a component of the computing device, wherein the electrical characteristic includes one or more of impedance, inductance, capacitance, or frequency response;
determining, by the processor, whether the value of the electrical characteristic is within a threshold amount of a baseline value of the electrical characteristic;
responsive to determining that the value of the electrical characteristic is within the threshold amount of the baseline value, completing the boot process; and
responsive to determining that the value of the electrical characteristic is not within the threshold amount of the baseline value, preventing the computing device from completing the boot process.

2. The method of claim 1, further comprising:
retrieving, from a secure memory of the computing device, the baseline value of the electrical characteristic of the connection.

3. The method of claim 2, wherein the secure memory is a one-time programmable read-only memory that includes one or more of hardware fuses, hardware antifuses, or software fuses.

4. The method of claim 2, wherein the secure memory is included within one or more of a system memory of the computing device, the processor of the computing device, or a dedicated hardware processor distinct from the processor.

5. The method of claim 1, wherein the electrical characteristic includes one or more of impedance, inductance, capacitance, frequency response, timing delay, timing difference, step function response, overshoot, or damping.

6. The method of claim 1, wherein determining, by the processor, whether the value of the electrical characteristic is within the threshold amount of the baseline value of the electrical characteristic comprises:
applying a correction factor to the value of the electrical characteristic to generate an corrected value of the electrical characteristic; and
determining whether the corrected value of the electrical characteristic is within the threshold amount of the baseline value of the electrical characteristic.

7. The method of claim 1, further comprising, while the computing device is operating in a secure environment:
determining, by the computing device, the baseline value of the electrical characteristic of the connection from the processor to the component of the computing device; and
storing, by the computing device, the baseline electrical characteristic in a secure memory of the computing device.

8. The method of claim 7, wherein the secure environment is an assembly site of the computing device.

9. A computing device comprising:
a processor;
one or more hardware components;
one or more communication channels configured to provide a respective connection between the processor and each of the one or more hardware components; and
a secure memory configured to store a baseline value of respective electrical characteristics for each of the respective connections between the processor and each of the one or more hardware components,
wherein the processor is configured to:
determine, during a boot process of the computing device, a value of an electrical characteristic of a particular connection between the processor and one of the one or more hardware components, wherein the electrical characteristic includes one or more of impedance, inductance, capacitance, or frequency response;
determine whether the value of the electrical characteristic of the particular connection is within a threshold amount of the baseline value of the electrical characteristic of the particular connection stored in the secure memory;
responsive to determining that the value of the electrical characteristic of the particular connection is within the threshold amount of the baseline value, complete the boot process; and
responsive to determining that the value of the electrical characteristic of the particular connection is not within the threshold amount of the baseline value, prevent the computing device from completing the boot process.

10. The computing device of claim 9, wherein the processor is configured to determine whether the value of the electrical characteristic is within a threshold amount of a baseline value of the electrical characteristic by at least being configured to:
apply a correction factor to the value of the electrical characteristic to generate an corrected value of the electrical characteristic; and
determine whether the corrected value of the electrical characteristic is within the threshold amount of the baseline value of the electrical characteristic.

11. The computing device of claim 9, wherein the processor is configured to, while the computing device is operating in a secure environment:
determine the baseline value of the electrical characteristic of the particular connection between the processor and the one of the one or more hardware components; and
store the baseline value of the electrical characteristic of the particular connection in the secure memory.

12. The computing device of claim 9, wherein the secure memory is a one-time programmable (OTP) read-only memory (ROM), and wherein the ROM includes one or more of hardware fuses, hardware anti-fuses, or software fuses.

13. The computing device of claim 9, wherein the secure memory is included within one or more of a system memory of the computing device or the processor.

14. The computing device of claim 9, wherein the electrical characteristic includes one or more of impedance, inductance, capacitance, frequency response, timing delay, timing difference, step function response, overshoot, or damping.

15. The computing device of claim 9, further comprising a system on a chip that includes the processor and the secure memory.

16. A non-transitory computer-readable storage medium encoded with instructions that, when executed, cause a processor of a computing device to:
determine, during a boot process of the computing device, a value of an electrical characteristic of a connection from the processor to a component of the computing device, wherein the electrical characteristic includes one or more of impedance, inductance, capacitance, or frequency response;
determine whether the value of the electrical characteristic is within a threshold amount of a baseline value of the electrical characteristic;
responsive to determining that the value of the electrical characteristic is within the threshold amount of the baseline value, complete the boot process; and
responsive to determining that the value of the electrical characteristic is not within the threshold amount of the baseline value, prevent the computing device from completing the boot process.

17. The non-transitory computer-readable medium of claim 16, wherein the instructions further cause the processor to:
retrieve, from a secure memory of the computing device, the baseline value of the electrical characteristics of the connection.

18. The non-transitory computer-readable medium of claim 17, wherein the instructions further cause the processor to, while the computing device is operating in a secure environment:
determine the baseline value of the electrical characteristic of the connection from the processor to the component of the computing device; and
store the baseline electrical characteristic in the secure memory.

19. The non-transitory computer-readable medium of claim 16, wherein the secure memory is a one-time programmable (OTP) read-only memory (ROM), and wherein the ROM includes one or more of hardware fuses, hardware anti-fuses, or software fuses.

20. The non-transitory computer-readable medium of claim 16, wherein the electrical characteristic includes one or more of impedance, inductance, capacitance, frequency response, timing delay, timing difference, step function response, overshoot, or damping.
